(19) United States
(12) Patent Application Publication
(10) Pub. No.: US 2021/0334349 A1
(43) Pub. Date: Oct. 28, 2021

(54) METHOD FOR THE ACQUISITION AND SUBSEQUENT GENERATION OF DATA FOR A USER OF A SELF-SERVICE TERMINAL

(71) Applicant: Daniel SCHELD, Bonn (DE)

(72) Inventor: Daniel SCHELD, Bonn (DE)

(21) Appl. No.: 17/268,294

(22) PCT Filed: Aug. 15, 2018
(86) PCT No.: PCT/DE2018/100712

§ 371 Date: Feb. 12, 2021

(51) Int. Cl. G06F 21/32; G06Q 20/18; G06K 9/00; G06Q 20/40

(52) U.S. Cl. CPC G06F 21/32; G06Q 20/40145; G06K 9/00483; G06Q 20/18

(57) ABSTRACT

A self-service terminal comprises at least one display and at least one input field. A plurality of different products and/or services stored in an internal or external database are displayed on the display and are made available to the user for selection. At least one official photographic document and/or electronic document on an electronic medium is read by at least one reading element. At least one document-specific feature of the user is optically acquired and stored. An authenticity check is carried out in by comparing the acquired document-specific features against the original values of the user read in from the photographic document and/or the electronic document. In the case of a positive authenticity check, an electronic and/or haptic document is generated and subsequently output and/or transmitted to the user, which authorizes the user to receive and/or to access and/or to perform the product and/or service previously selected.

### TECHNICAL FIELD

The present disclosure relates to a method for the acquisition and subsequent generation of data for a user of a self-service terminal, which comprises at least one display and at least one input field. The present disclosure also relates to a self-service terminal.

### BACKGROUND

It is known from the prior art that in order to handle different processes such as, for example, carrying out a specific transaction (both online and in the real world) in an ordering process, an identity check is required, by means of which the information provided by the user is verified so that the process selected by the user is enabled. For this purpose, an identity check is usually carried out by means of a plausibility check and inspection of various information provided by the user, however, it usually does not provide sufficient security, since such information may be known to third parties or can be easily determined by them. Often, however, identity checks are also carried out by the personnel handling the process using optical acquisition. Devices are also known from the prior art which are designed to carry out an automated identity check and in which a user is identified by determining document-specific features in the form of biometric scans.

However, none of these methods and systems is capable of offering a solution designed for different processes for selection and subsequent identification. Rather, known solutions are restricted in a very individual way to specific processes that are not amenable to selection.

### SUMMARY

The object of the present disclosure is to create a method which overcomes the aforementioned problems.

The above object is achieved by the subject matter of the independent claim(s). Advantageous configurations and developments of the method are specified in the dependent claims.

A method of the type mentioned at the outset is characterized by the following method steps, wherein the method sequence is not intended to be limited to the sequence of individual method steps described.

A plurality of different products and/or services stored in an internal or external database are displayed on the display of a self-service terminal and are made available to the user for selection using the at least one input field. Such products and/or services can be of many different types, and so only a few examples are mentioned here, such as ordering official documents, financial payments, bookings, reservations, product purchases, etc. A core aspect is to offer the user a selection of a plurality of different products and/or services in the process.

In a further method step, the data collected by the user are stored—at least temporarily—for further utilization as part of the product and/or service selection.

Another method step provides that at least one official photographic document and/or electronic document on an electronic medium is read in by means of at least one reading element for acquiring official photographic documents and/or documents stored on an electronic medium. This document can be, for example, an identity card, passport, driving license or other photographic documents or documents electronically stored on an electronic medium (e.g. the digital signature or digitally stored images on an identity card). It is particularly advantageously provided that the official photographic documents are recorded by photographic exposure in the light spectra of the near infrared, white light, ultraviolet light, oblique light and phase-aligned light. Within this process section, document-specific security features can advantageously also be checked on the basis of the relevant statutory documentation of the security features, and text components and/or photographs in the near infrared as well as white and ultraviolet light, photographs, fingerprints, iris data and/or iris images, text components, document images, signatures and/or certificates can be extracted from existing electronic chips. Furthermore, provision is preferably made for temporarily recording, by means of photographic recording, a live image of the identity card user and/or fingerprints of the identity card user for further analysis.

Another method step consists in carrying out an optical acquisition and—at least temporary—storage of the at least one document-specific feature of the user. The optical detection of document-specific features can be based on known methods, such as the biometric scan of a person such as, e.g., iris and face scanning, fingerprint scanning or similar biometric scanning methods and systems, which are sufficiently well known from the prior art and will not be discussed in more detail here.

After at least one document-specific feature of the user has been acquired and photographic documents and/or electronic documents on an electronic medium have been read in, it is provided that an authenticity and/or legitimacy check is carried out in the form of a comparison of the acquired document-specific features against the user's original values read in from the photographic document and/or from the electronic document. The comparison is advantageously carried out by a program installed in the self-service terminal or stored externally and designed for access by the self-service terminal, which program contains at least one comparison algorithm.

In the case of a positive authenticity and/or legitimacy check, according to the method an electronic and/or haptic document is generated and subsequently output and/or transmitted to the user and/or to one or more recipients, which authorises the user to receive and/or to access and/or carry out the product and/or service selection made.

In a particularly advantageous embodiment, on the basis of the determined data a user-defined scoring is carried out on the basis of results lists available after checks, wherein a visible and/or invisible output of the scoring result and/or a notification and/or reporting process is triggered.

Furthermore, it is advantageous to enter the determined data in one or more of the form(s) assigned to the product selection and/or service selection carried out by the user, which is advantageously forwarded to a specific recipient, e.g. via suitable interfaces to an external system for further inspection and/or processing, or is issued to the user. In this context, it is also conceivable that an optically readable code is generated from the determined data and this is printed out.

The external system can be, for example, a system for accepting or dispensing money.

A live image, photograph, ID card image or a similar type of recorded image of the user is preferably displayed on the external system (for example a checkout in a supermarket), by means of which a new identity check can be carried out.

It can be advantageous, moreover, that in the event of errors, unauthorized hardware accesses and/or software accesses, the system of the self-service terminal is terminated and restored to its original state from an encrypted, stored data image.

It is particularly advantageous that—preferably all—the method steps are documented in an audit-compliant manner.

### BRIEF DESCRIPTION OF THE DRAWINGS

Further objectives, features, advantages and possible applications of the method according to the invention will emerge from the following description of an exemplary embodiment with reference to the drawing.

FIG. 1 shows a self-service terminal in side view.

### DETAILED DESCRIPTION

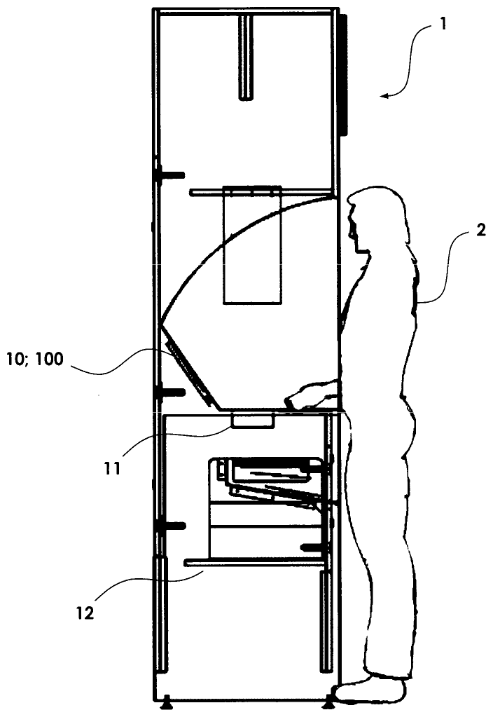

FIG. 1 shows a self-service terminal 1 for the acquisition and subsequent generation of data for a user, which comprises at least one display 10 and at least one input field 100. The self-service terminal 1 is includes the following features:

It comprises a database or an access unit to an external database having different products and/or services, which are made available to the user 2 on the display 10 for selection by means of the at least one input field 100.

Furthermore, a memory or an access unit to an external memory is provided for storing—at least temporarily—the data collected from the user 2 as part of the product selection for further utilization.

The self-service terminal 1 comprises a reading element 11 by means of which official photographic documents and/or documents stored on an electronic medium and at least one document-specific feature can be acquired and then stored—at least temporarily—on a suitable medium.

The self-service terminal 1 additionally comprises an evaluation unit or an access unit to an external evaluation unit for carrying out an authenticity and/or legitimacy check in the form of a comparison of all data and photographs collected against the original values of the user stored in the photographic document and/or on the electronic document.

In addition, an output element 12 is provided, by means of which, in the case of a positive authenticity and/or legitimacy check, an electronic and/or haptic document is output and/or transmitted to the user and/or to one or more recipients, which authorizes the user to receive and/or to access and/or to carry out the product and/or service selection made.

In a particularly advantageous embodiment, the output element 12 is a printer, for example, specifically a barcode printer. The output element 12 can additionally be or comprise an interface for connecting the self-service terminal 1 to external systems.

### Exemplary Embodiment for Activating a Prepaid Telephone Card

A user approaches the self-service terminal 1. A biometric camera has already captured this and a template (including the recognition of biometric features) is created from the face. The user selects a product on the input field 100. In this case the identification proceeds according to Sec. 111 TkG (German Telecommunications Act) to activate a prepaid telephone card. The self-service terminal 1 prompts the user to place a valid identification document on the reading element 11 (here a passport scanner). For this purpose, a video or several pictograms can be displayed on the display 10 for assistance and explanation. The scanning operation starts automatically when the identification document is inserted. The document is classified and, if necessary, the user is prompted to turn the document over (only for double-sided identification documents). An authenticity analysis of the identification document is carried out, but is not displayed to the user. The biometric features of the user's face (template) are then compared with the biometric features of the facial images of the identification card. In the background, all permissible data sources for identity verification, document checking and security are queried. The text features of the identification document are then read out and the transaction-/product-specific forms are filled out and offered for correction. On selecting a function to complete the procedure, the transaction is ended and the relevant data is forwarded to the relevant mobile network operator in compliance with the rules so that the mobile network card can be activated or blocked. This ends the procedure.

### Exemplary Embodiment for Carrying Out a Money Transfer

A user approaches the self-service terminal 1. A biometric camera has already captured this and a template (including the recognition of biometric features) is created from the face. The user selects a product on the input field 100. In this case, a money transfer to a person/company at home or abroad. The self-service terminal 1 prompts the user to place a valid identification document on the reading element 11 (here a passport scanner). For this purpose, a video or several pictograms can be displayed on the display 10 for assistance and explanation. The scanning operation starts automatically when the identification document is inserted. The document is classified and, if necessary, the user is prompted to turn the document over (only for double-sided identification documents).

An authenticity analysis of the identification document is carried out, but is not displayed to the user. The biometric features of the user's face (template) are then compared with the biometric features of the facial images of the identification card. In the background, all permissible data sources for identity verification, document checking and security are queried. The user records the destination country, recipient of the payment, currency and specifies the amount of money to be transferred and the currency. A purpose and other information can also be recorded. A rule-compliant risk analysis is carried out. As part of the analysis, the user is asked case-specific questions which the user must answer by selecting answers on the display 10 and/or by using the input field 100. A payment receipt is then printed out, which the user has to sign. If the receipt is signed, the self-service terminal 1 prompts the user to place the receipt in a predefined area so that the receipt can be photographed. When the photograph is taken, the machine checks whether it is the document relating to the current transaction and whether the receipt is signed in the correct place. For this purpose, the receipt contains one or more machine-readable symbols, such as barcodes. Once the procedure is complete, the user goes to the cash counter of the company in whose premises the machine is located. At the counter, the receipt is then scanned using the barcode. The cashier now performs a query of the assigned product to the database of the self-service terminal 1. The cashier is shown a current photograph, as well as the surname, first name and age of the user. The responsible cashier then confirms whether it is the intended person or terminates the process (two-stage identification). If the identification is successful, the cashier then transfers the product, the payment direction, the amount and other data into the till roll for the purpose of making deposits or withdrawals. As soon as the amount has been paid in or paid out, a request is made to the machine data and the database of a service provider for the money transfer in order to record the payment accordingly and to record it on the till receipt with the transaction code. After printing out the till receipt, the user receives it and the transaction is completed.

The embodiment of the method according to the invention is not limited to the preferred embodiments specified above. Rather, a wide range of design variations are conceivable, which make use of the solution shown even if their embodiment is fundamentally different.

### LIST OF REFERENCE SIGNS

1 self-service terminal
2 user
10 display
11 reading element
12 output element in the form of a printer
100 input field

1.-14. (canceled)

15. A method for acquisition and subsequent generation of data for a user (2) of a self-service terminal (1) which includes at least one display (10) and at least one input field (100), comprising the following method steps:
a) displaying a plurality of different products and/or services stored in an internal or external database on the display (10), which are made available to the user (2) for selection using the at least one input field (100);
b) at least temporarily storing the data collected by the user (2) for further utilization as part of the product and/or service selection;
c) reading in a user's original values from at least one official photographic document and/or electronic document on an electronic medium by at least one reading element (11) for acquiring official photographic documents and/or documents stored on an electronic medium;
d) optically acquiring a document-specific feature of the user and storing it at least temporarily;
e) checking authenticity and/or legitimacy by comparing the acquired document-specific feature against the user's original values read in from the photographic document and/or from the electronic document; and
f) in case of a positive authenticity and/or legitimacy check, generating and subsequently outputting and/or transmitting to the user (2) and/or to one or more recipients an electronic and/or haptic document, which authorizes the user (2) to receive and/or to access and/or carry out the product and/or service selection made in a).

16. The method according to claim 15, wherein at least one document-specific feature is acquired by a biometric scan of the user.

17. The method according to claim 15, wherein the official photographic documents are recorded by photographic exposure in the light spectra of near infrared, white light, ultraviolet light, oblique light and phase-aligned light.

18. The method according to claim 15, wherein based on data determined during steps a), c) and d) a user-defined scoring is carried out on the basis of results lists available after checks, wherein a visible and/or invisible output of the scoring result and/or a notification and/or reporting process is initiated.

19. The method according to claim 15,
wherein data determined during steps a), c) and d) are entered in one or more of the form(s) assigned to the product selection and/or service selection carried out by the user (2).

20. The method according to claim 15, wherein an optically readable code is generated from the data determined during steps a), c) and d) and is printed out.

21. The method according to claim 15, wherein the data determined during steps a), c) and d) are transferred to external systems via interfaces.

22. The method according to claim 21, wherein the external system is a system for accepting or dispensing money.

23. The method according to claim 21, wherein a live image, photograph, ID card image or a similar type of recorded image of the user is displayed on the external system, by which a new identity check can be carried out.

24. The method according to claim 15, wherein in an event of errors or unauthorized hardware accesses and/or software accesses, the self-service terminal (1) is terminated and restored to its original state from an encrypted, stored data image.

25. The method according to claim 15, wherein all method steps are documented in an audit-compliant manner.

26. A self-service terminal (1) for acquisition and subsequent generation of data for a user, comprising:
at least one display (10);
at least one input field (100);
a database or an access unit to an external database having different products and/or services, which are made available to the user (2) on the display (10) for selection by the at least one input field (100);
a memory or an access unit to an external memory for storing, at least temporarily, the data collected from the user (2) as part of the product selection for further utilization;
a reading element (11) by which official photographic documents and/or documents stored on an electronic medium and at least one document-specific feature are acquired and at least temporarily stored;
an evaluation unit or an access unit to an external evaluation unit for carrying out an authenticity and/or legitimacy check by comparing all data and photographs collected against the original values of the user stored in the photographic document and/or on the electronic document; and
an output element (12) by which, in case of a positive authenticity and/or legitimacy check, an electronic and/or haptic document is output and/or transmitted to the user (2) and/or to one or more recipients, which authorizes the user (2) to receive and/or to access and/or to carry out the product and/or service selection.

27. The self-service terminal (1) according to claim 26, wherein the output element (12) is a printer.

28. The self-service terminal (1) according to claim 26, wherein the output element (12) is or comprises an interface for connecting the self-service terminal (1) to external systems.
